(19) United States
(12) Patent Application Publication
(10) Pub. No.: US 2011/0110704 A1
(43) Pub. Date: May 12, 2011

(54) COVER FOR BINDING A BUNDLE OF SHEETS

(76) Inventor: Guido PELEMAN, Antwerpen (BE)

(21) Appl. No.: 12/939,615

(22) Filed: Nov. 4, 2010

(30) Foreign Application Priority Data
Nov. 6, 2009 (BE) 2009/0688

(51) Int. Cl. B42F 13/00

(52) U.S. Cl. 402/73

(57) ABSTRACT

A cover for the binding of a bundle of sheets, includes a spine with flaps attached thereto, the cover including in addition a loose binding profile with a bottom and two legs between which a bundle of sheets can be clasped. The binding profile is made from a springy or other material or comprises a hinge that allows the legs to move toward or away from one another and which binding profile can be attached to the spine of the cover after the bundle of sheets has been clasped.

### BACKGROUND OF THE INVENTION

A. Field of the Invention

The present invention relates to a cover for binding a bundle of sheets.

B. Related Art

Preformed covers of a springy material whereby the sheets to be bound can be pushed between the front and back flaps by stretching the spine open are already known.

A disadvantage is that the bound bundle obtained remains difficult to keep open and that, certainly with thick bundles, problems can arise with the visibility or legibility of the sheets in the area closest to the spine.

Another disadvantage is that the cover must be selected depending on the bundle of sheets to be bound.

An additional disadvantage is that these covers are difficult to manufacture and hence expensive.

### SUMMARY OF THE INVENTION

The aim of the present invention is to offer a solution to one or more of the aforementioned and/or other disadvantages by providing a cover for binding a bundle of sheets, whereby the cover comprises a spine with flaps attached thereto, characterised in that the cover comprises in addition a loose binding profile with a bottom and two legs between which a bundle of sheets can be clasped, said binding profile is made from a springy or other material or comprises a hinge that allows the legs to move toward or away from one another and which binding profile can be attached to the spine of the cover after the bundle of sheets has been clasped.

An advantage is that the bound bundle of sheets is secured firmly in the cover and cannot come loose under the effect of a tractive force, irrespective of the direction of that force.

Another advantage is that binding a bundle of sheets in the cover is very simple, so that the cover is very user friendly.

This is because it is sufficient to insert the bundle of sheets in the binding profile and then to attach the binding profile to the spine of the cover.

A further advantage is that the cover is simple to manufacture since the binding profile and the cover are easy to make as separate components.

An advantage associated with this is that the cover is cheap to make.

In the most practical embodiment of the invention the binding profile is attached with its bottom against the spine of the cover by means of a self-adhesive glue.

An advantage is that the binding profile can be positioned and attached precisely, which obviously contributes to the aesthetic character of the bound cover.

Means are preferably provided to prevent a bundle clasped in the binding profile being pulled out of the binding profile in a crosswise direction.

In the most preferred embodiment of the invention there are pegs in the binding profile that cut through the bundle.

An advantage is that a strongly bound cover is obtained whereby the sheets cannot come loose from the cover.

Another advantage is that repeatedly opening up the bundle and pressing it flat has no effect on the binding of the bundle in the cover.

An associated advantage is that the life of the bound cover is extended considerably.

### DESCRIPTION OF THE DRAWINGS

To better demonstrate the characteristics, hereafter a preferred embodiment of a cover according to the invention is described by way of example, without any limiting nature, with reference to the attached drawings, wherein:

FIG. 1 shows schematically and in perspective a cover according to the invention after a bundle of sheets has been bound in the cover;

FIG. 2 shows on a larger scale the part indicated by the arrow F2 in FIG. 1;

FIG. 3 shows schematically and in perspective the binding profile from FIG. 1;

FIG. 4 shows a variant of the binding profile in FIG. 3.

### DETAILED DESCRIPTION OF PREFERRED EMBODIMENTS OF THE INVENTION

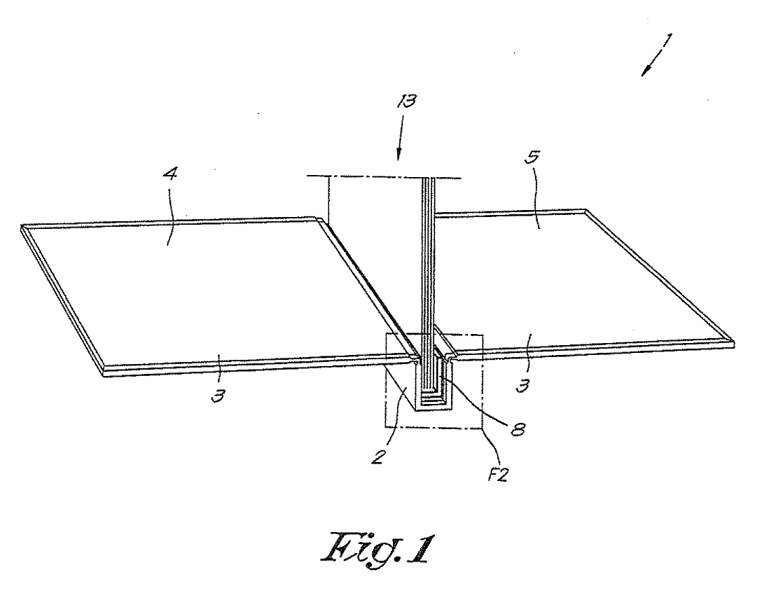

FIG. 1 shows schematically a cover 1 with a bound bundle, whereby the cover consists chiefly of a spine 2 and two flaps 3 attached thereto, a front flap 4 and a back flap 5 respectively.

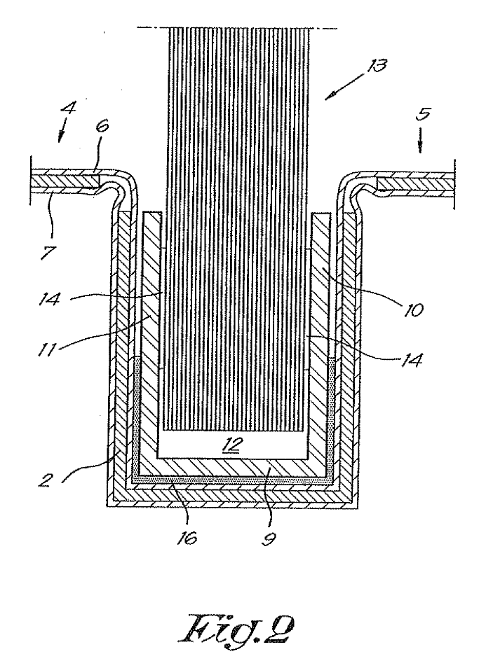

As is known, the aforementioned flaps 3 and spine 2 can be formed together as a single continuous structure, but it is also possible for the spine 2 and the flaps 3 to be embodied as separate elements that are attached to one another by means of an internal or external covering 6-7, as shown in FIG. 2.

In a practical embodiment of the invention the spine 2 may be preformed.

Preferably the spine 2 of the cover is somewhat U-shaped, whereby in the most practical embodiment the legs of the spine converge somewhat.

Preferably the spine 2 of the cover 1 is made from metal or steel, but it is clear to a man skilled in the art that a number of materials can be employed in the spine 2 and flaps 3.

According to the invention a binding profile 8 of a springy or other material is attached to the spine 2 of the cover 1.

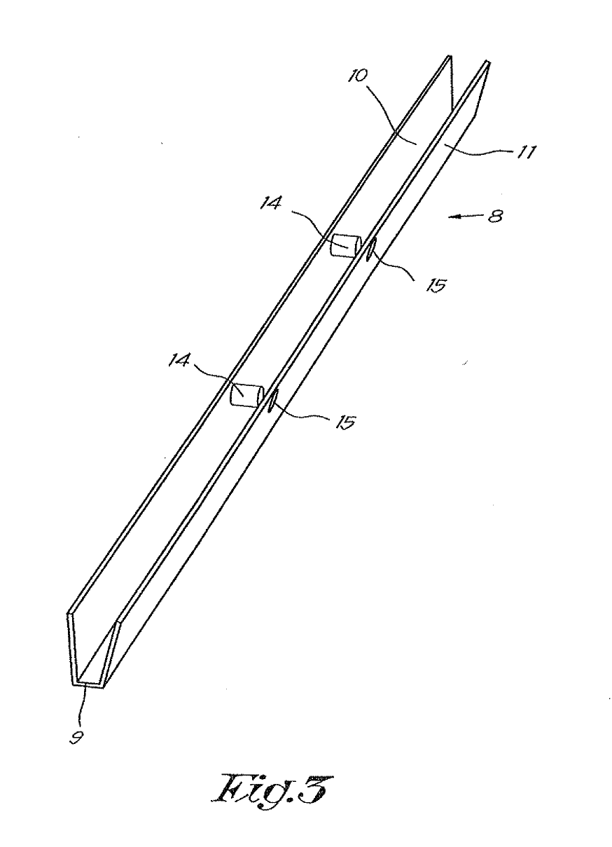

In a practical embodiment of the invention, as shown in FIG. 3, the binding profile 8 is a U-shaped profile.

In the most practical embodiment of the invention the external shape of the binding profile 8 and the internal shape of the spine 2 are substantially matched to one another such that the binding profile 8 can be pushed into the spine 2 along its longitudinal axis.

In a practical embodiment of the invention the binding profile 8 is made from a synthetic material, such as, for example, plastic or some other man-made material, or from a springy or other metal, but the invention is not limited thereto.

According to the invention the binding profile 8 comprises a bottom 9 with two upright legs or sidewalls 10-11.

In a practical embodiment of the invention the binding profile 8 comprises a hinge that allows the legs 10-11 to move toward or away from one another.

In the embodiment shown the thickness of the binding profile 8 is somewhat thinner at the transitions between the legs 10-11 and the bottom 9, but this is not a requirement of the invention.

The aforementioned bottom 9 and legs 10,11 enclose a space 12 into which the bundle of sheets to be bound 13 can be inserted.

Preferably the legs 10,11 of the binding profile 8 are parallel to one another or converge somewhat with one another.

In a practical embodiment the length of the binding profile 8 is approximately equal to or less than the length of the spine 2 of the cover 1, such that in the closed position of the cover 1 the binding profile 8 is not perceptible.

In the most preferable embodiment means are provided on the binding profile 8 to prevent accidental removal of the bundle 13 from the binding profile 8.

In the embodiment in FIG. 3 two pegs 14 are provided for this purpose on the inward-facing side of one of the legs 10.

The aforementioned pegs 14 are cylindrical and have a length that is greater than or equal to the thickness of the bundle 13 to be bound.

Preferably the pegs 14 are provided with cutting edges, but in alternative embodiments they can also take other forms and, for example, end in a sharp point.

Opposite these pegs 14 the other leg 11 is provided with depressions 15 of which the diameter corresponds to the diameter of the pins 14.

In the embodiment of FIG. 3 two pins 14 and two depressions 15 are provided on the binding profile 8, but an embodiment with only one peg 14 or with more than two pegs 14 is also possible.

In another embodiment of the invention not shown in the figures, the means of avoiding accidental removal can comprise a thickened part of the inner side of the legs 10-11, whether or not close to the free-standing edges, all such that the bundle 13 inserted is clasped between the thickened edges.

In another embodiment not shown in the figures the legs 10-11 may be provided on their inside with one or more projections or the legs 10-11 may be provided with an inward-folded edge or a double-folded edge.

In each of the aforementioned embodiments it is impossible for a bundle 13, whether or not stapled beforehand, to come loose because of a tractive force in a crosswise direction, since the staples in the bundle are placed behind a thickened part, projection or folded edge.

As shown in FIG. 2, the U-shaped binding profile 8 is preferably attached with its bottom 9 in the cover 1.

The legs 10-11 of the binding profile 8 may also be partly attached to the cover 1 or may be fitted so as to be freely moveable relative to the spine 2 and flaps 3.

In a practical embodiment the aforementioned attachment of the binding profile 8 to the cover is done by means of a glue layer 16.

In the most preferable embodiment a self-adhesive type of glue is used, such that no heat is required when attaching the binding profile 8 to the cover 1.

The aforementioned glue layer may be provided both on the outside of the binding profile 8 or on the spine 2 of the cover 1, in the form of a self-adhesive strip or otherwise to which a covering film may be applied or otherwise.

It goes without saying that the use of a heat sensitive melting glue 11 in a cover 1 is possible according to the invention.

In a practical embodiment of the invention the binding profile 8 is only attached against the spine 2 of the cover 1, but in alternative embodiments it is also possible for one of the two legs 10-11 to be partly stuck to the inside of a flap 3.

Obviously the attachment of the binding profile 8 to the cover 1 need not necessarily be done by means of glue 16, but rather the binding profile 8 may also be attached to the cover 1 in other ways, for example by providing barbs on the outside of the binding profile 8.

Such an embodiment whereby the outside of the binding profile 8 comprises one or more projections, preferably in the form of the aforementioned barbs, avoids the binding profile 8 being removed from the spine 2, at an undesired moment.

Method for binding a bundle of sheets 13 by means of a cover 1 according to the invention is very simple and as follows.

In a first step the bundle of sheets 13 to be bound may or may not be bound together, for example by means of one or more staples.

The bundle may also be pre-perforated if necessary, but this is not strictly required if a binding profile 8 with sharp pegs 14 is used.

It is obvious to a man skilled in the art that in the case of the pegs 14 of the binding profile 8 having blunt ends, such pre-perforation of the bundle 13 is the better choice.

Irrespective of whether or not it is pre-perforated and/or bound together, the bundle to be bound 13 can be clasped in the loose binding profile 8.

In addition, the legs 10-11 of the binding profile 8 may be opened up a little near their free extremities.

In the preferred embodiment with sharp pegs 14 on the leg 10, the sheets in the bundle 13 will automatically be perforated when they are inserted.

In a subsequent step the legs 10-11 of the binding profile 8 may be pressed toward one another, so that the sharp edges of the pegs 14 are pressed into the depressions 15 in the other leg 11 and the bundle 13 is clasped firmly in the profile.

In a subsequent step the binding profile 8 can be attached to the spine 2 of the cover 1, either by a glue layer 16 on the binding profile 8, or by a glue layer 16 on the cover 1, whereupon the bound bundle is firmly attached to the cover.

According to a practical variant of the invention it is possible in addition, after the binding profile 8 with the clasped bundle of sheets 13 has been closed, for the binding profile 8 with the bundle 13 clasped therein to be attached to the cover 1, for example by applying the binding profile 8 to one of the two transverse edges of the cover 1 and then sliding the binding profile 8 to the desired position along the longitudinal axis of the spine 2.

It is clear that in a cover 1 with a spine 2 with converging legs, the binding profile 8 will be difficult to pull free by a crosswise force, if the distance between the extremities of the legs of the spine 2 is approximately equal to the thickness of the bundle of sheets 13.

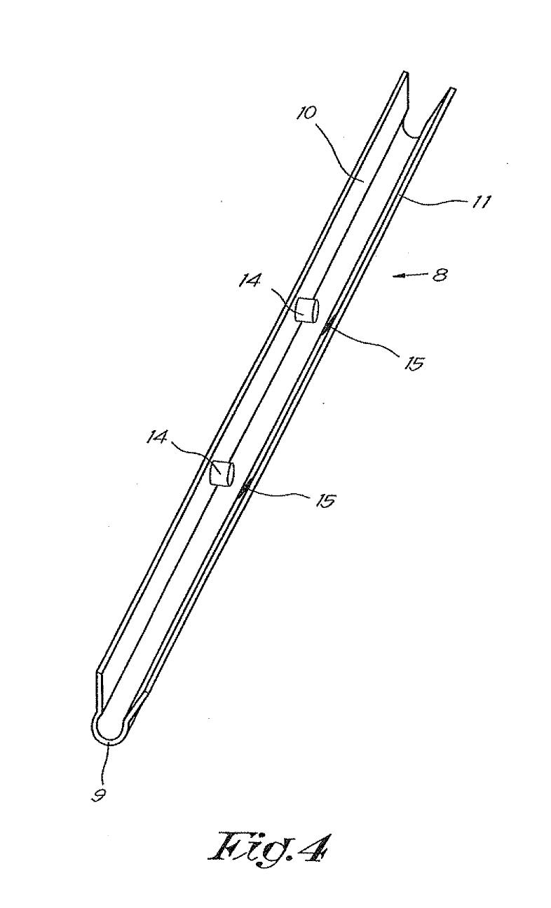

FIG. 4 shows an alternative embodiment whereby the bottom of the binding profile 8 is not flat but is made in the form of an arc.

Such a binding profile 8 is extremely suitable for being fitted to a cover 1 with a preformed spine that is given a suitable shape.

This binding profile is also provided with two pegs 14 on one leg 10 and depressions 15 on the other leg 11.

Although it is preferable to provide the pegs 14 with sharp or cutting edges, the pegs may also be blunt so that a pre-perforated bundle of sheets 13 can easily be inserted by sticking the pegs 14 through the pre-perforated holes in the sheets.

The present invention is by no means limited to the embodiments described as an example and shown in the figures, but a cover 1 according to the invention for the binding of a bundle of sheets 13 may be realised in all shapes and dimensions without departure from the scope of the invention.

1. Cover for binding a bundle of sheets, comprising:
a spine with flaps attached thereto;
a loose binding profile with a bottom and two legs for receiving a bundle of sheets edgewise;
said binding profile being made from a springy material or comprising a hinge that enables the legs to move toward or away from each other to clasp a bundle of sheets between the legs;
said binding profile being attachable to the spine of the cover after a bundle of sheets has been clasped by the two legs.

2. Cover according to claim 1, wherein the bottom of the binding profile is attached to the spine of the cover.

3. Cover according to claim 1, wherein the external shape of the binding profile and the internal shape of the spine are substantially matched to one another such that the binding profile is slidable onto the spine along a longitudinal axis of the spine.

4. Cover according to claim 1, wherein at least one leg of the binding profile comprises one or more pegs pointing toward the other leg.

5. Cover according to claim 4, wherein each peg has a sharp point or cutting edge.

6. Cover according to claim 1, wherein at least one leg of the binding profile is provided with an inward-folded edge or double-folded edge.

7. Cover according to claim 1, wherein the binding profile is made from a synthetic material or from a springy metal.

8. Cover according to claim 1, wherein the spine of the cover is pre-formed.

9. Cover according to claim 1, wherein the cover comprises a metal or steel spine.

10. Cover according to claim 1, wherein the spine of the cover is U-shaped.

11. Cover according to claim 1, wherein the binding profile is provided with means for attaching the binding profile to the cover.

12. Cover according to claim 11, said means comprising a glue layer or a self-adhesive glue strip on the spine of the cover and/or on the binding profile.

13. Cover according to claim 1, wherein said means comprises one or more projections on the outside of the binding profile, whereby the binding profile cannot accidentally be removed again from the spine.
